(19) United States
(12) Patent Application Publication
(10) Pub. No.: US 2018/0370763 A1
(43) Pub. Date: Dec. 27, 2018

(54) ELEVATOR SYSTEM WITH A SPEED-VARIABLE ELEVATOR CAR, AND OPERATING METHOD OF THE ELEVATOR SYSTEM

(71) Applicant: Inventio AG, Hergiswil (CH)

(72) Inventors: Martin Kusserow, Luzern (CH); Reto Tschuppert, Luzern (CH)

(21) Appl. No.: 16/064,035

(22) PCT Filed: Dec. 22, 2016
(86) PCT No.: PCT/EP2016/082429

§ 371 Date: Jun. 20, 2018

(30) Foreign Application Priority Data
Dec. 23, 2015 (EP) 15202485.7

(51) Int. Cl. B66B 5/00

(52) U.S. Cl. CPC B66B 5/005; B66B 5/0025; B66B 5/0093

(57) ABSTRACT

An elevator system includes a counterweight and an elevator car supported by support device and moved in opposite directions in an elevator shaft. In an operating method for operating the elevator system, the elevator car approaches the counterweight and/or moves past the counterweight in an approach zone in the elevator shaft, and the elevator car moves at a first speed outside of the approach zone and at a second speed in the approach zone, the second speed being lower than the first speed.

### FIELD

The invention relates to an elevator system comprising a counterweight and an elevator car, which are supported by support means guided by at least one diverting means and are moved in opposite directions in an elevator shaft, and to an operating method for operating an elevator system of this type.

### BACKGROUND

In an elevator system comprising an elevator car in an elevator shaft, a counterweight connected to the elevator car by support means guided by at least one diverting means is moved in the opposite direction to the elevator car. Generally, the elevator car and the counterweight move past one another in quite close proximity approximately halfway up the elevator shaft. Because, for example during maintenance or installation work on the elevator system, one or more technicians work on the top of the elevator car and their body/bodies may often protrude beyond the edge of the top, the counterweight may hit the technician(s) when it passes the elevator car. A collision needs to be prevented as far as possible in this case.

JP 2011051786 A discloses an elevator system in which a light projector is arranged close to the bottom of an elevator shaft or at the lower limit of the maximum range of movement of a counterweight, in order to project light in a horizontal direction. A light sensor is arranged in the elevator shaft at the same height as the light projector in order to receive the projected light. If the light sensor detects that a technician is protruding over the edge, the elevator car and the counterweight are stopped.

EP 2516310 B1 describes an elevator system comprising a counterweight guide. The elevator car and the counterweight move past one another in an elevator shaft in what is known as an encounter zone. To prevent a collision or obstruction when they move past one another, the counterweight guide is designed such that the counterweight can be guided counter to the elevator car in the encounter zone by mechanical interaction between the elevator car and the counterweight guide, and between the counterweight and the counterweight guide.

In this case, the counterweight guide is a movable counterweight guide comprising a guide rail fastened to the elevator car, and corresponding guide means are provided on the counterweight which can temporarily engage in the guide rail on the elevator car while the elevator car is moving past the counterweight.

### SUMMARY

One aspect of the present invention can be considered that of improving the safety of an elevator system, in particular during maintenance or installation work, and in particular of minimizing the impact of the safety measure.

According to the invention, an elevator system is provided that comprises an elevator car and a counterweight, which are moved in an elevator shaft and are interconnected by support means guided by at least one diverting means, such that the elevator car and counterweight can be moved in opposite vertical directions. The elevator car approaches the counterweight in an approach zone and/or moves past the counterweight. The elevator car moves at a first speed outside of the approach zone and at a second speed in the approach zone, the second speed being lower than the first speed. Since the elevator car and the counterweight now move more slowly past one another, a person who e.g. has to remain on the top of the elevator car during maintenance work has more time to notice or react to the fact that the counterweight is approaching. The safety of this elevator system, in particular the safety against the risk of a collision, is thus improved.

Furthermore, an operating method according to the invention for an elevator system comprising a counterweight and an elevator car is specified, in which the elevator car and the counterweight are supported by support means and move in opposite directions in an elevator shaft, the elevator car approaching the counterweight and/or passing the counterweight in the elevator shaft in an approach zone, wherein the elevator car moves at a first speed outside of the approach zone and at a second speed in the approach zone, the second speed being lower than the first speed.

According to the invention, the elevator system is controlled in the shaft by means of an elevator controller comprising in particular a positioning system for determining the position of the elevator car and/or the counterweight. In particular, the method steps in the operating method according to the invention are executed in the elevator controller and the elevator system is controlled as a result. A position or the height of the elevator car or counterweight in the elevator shaft can be determined by a positioning system of the elevator system; a positioning system of this type is disclosed and set out e.g. in EP 1412 274 B1.

According to an advantageous embodiment of the present invention, the approach zone has a length in a movement direction of the elevator car that is greater than or equal to the greater height of the elevator car and the counterweight plus the height of a person, the height of a person being predetermined in accordance with the average height of a person from a country in which said elevator system is installed or is intended to be installed. The average height of a person varies from country to country and ranges between approximately 1.55 meters and 1.85 meters. Taking into account a safety buffer (e.g. 0.5 meters), the average height of a person may be specified as being e.g. 2.2 meters.

According to another advantageous embodiment of the present invention, although a center line of the approach zone and a center line of the elevator shaft are substantially at the same height, usually approximately halfway up the elevator shaft, the center line of the approach zone is above the center line of the elevator shaft because the height of a person on the top of the elevator car still needs to be taken into account. The center line of the approach zone is higher than the center line of the elevator shaft by approximately half the average height of a person, the two center lines being orthogonal to the movement direction of the elevator car. Since the length of the approach zone is great enough, the second speed can still be initiated in good time, before the counterweight passes the elevator car. Therefore, said person can identify the risk of a collision in good time and can react accordingly.

According to an alternative advantageous embodiment of the present invention, the approach zone is substantially symmetrical to a virtual reference line above the elevator car, the reference line being orthogonal to the movement direction of the elevator car and the distance between this reference line and the top of the elevator car corresponding to half the predetermined height of a person. By means of an arrangement of this type, the approach zone can be specified to be shorter than the embodiment of the invention set out above, because the length of the approach zone is no longer dependent on the height of the elevator car and the counterweight, but only on the height of the person. This means that it is unimportant whether the length of the elevator car or the counterweight is greater. The length of the approach zone can thus be specified comparatively more flexibly.

According to another advantageous embodiment of the present invention, the length of the approach zone in a movement direction of the elevator car is greater than or equal to half the length of the predetermined height of a person. In addition, the length of the approach zone may include at least one safety clearance, which is assigned to the upper and/or the lower boundary of the approach zone. Similarly to the above-mentioned safety buffer, the safety clearance may for example be set between zero and 0.5 meters, as required. Therefore, the lower boundary of the approach zone is at the height of the top of the elevator car or lower than this height; at this height, an upper edge of the counterweight is moved past the top of the elevator car when the elevator car moves counter to the counterweight from the top or from the bottom. If there are two safety clearances, they are assigned to the upper and the lower boundaries of the approach zone, respectively. In this case, the lower boundary of the approach zone is then lower than the top of the elevator car for a safety clearance. The two safety clearances may be identical or different.

According to another advantageous embodiment of the present invention, the second speed is set such that a change from the first speed to the second speed is perceptible by humans. This means that this change in speed is abrupt and thus rapid enough for a person to notice the change in speed. By contrast, the change back from the second speed to the first speed is more gradual and slower than the change from the first speed to the second speed. Preferably, braking, i.e. from the first speed to the second speed, is perceptible, and acceleration, namely from the second speed to the first speed, is a gradual, transitional change, so that a person who is e.g. carrying out maintenance work on the top of the elevator car can maintain their position and keep their balance better and more safely. This further improves safety.

Alternatively, the elevator system may comprise a warning device, such as a speaker, a vibration alarm or visual equipment, for discontinuously or not continually generating an acoustic, vibrating and/or visual alarm signal when changing from the first speed to the second speed. A warning device of this type can either be fastened in the elevator shaft close to the approach zone or on the top of the elevator car, or as a portable device e.g. in a protective helmet or in work clothing, or can be integrated in a mobile device, such as a smartphone, as a piece of software.

Advantageously, the operating method can be used during maintenance, installation and/or a test process for the elevator system. The operating method can be initiated and carried out either automatically by a control system of the elevator system or manually by a person who needs to be on the top of the elevator car to complete work.

The invention is explained in greater detail in the following with reference to the drawings in the context of an embodiment.

### DESCRIPTION OF THE DRAWINGS

In the drawings:

FIG. 1 is a schematic view of an elevator system according to the invention,

FIG. 2 shows four schematic views of an alternative elevator system according to the invention, representing a chronological sequence of the elevator car and the counterweight in the approach zone,

FIG. 3 shows the change between the first speed and the second speed on the basis of a direction of travel of the elevator car from the top towards the bottom, and

FIG. 4 shows the change between the first speed and the second speed on the basis of a direction of travel of the elevator car from the bottom towards the top.

### DETAILED DESCRIPTION

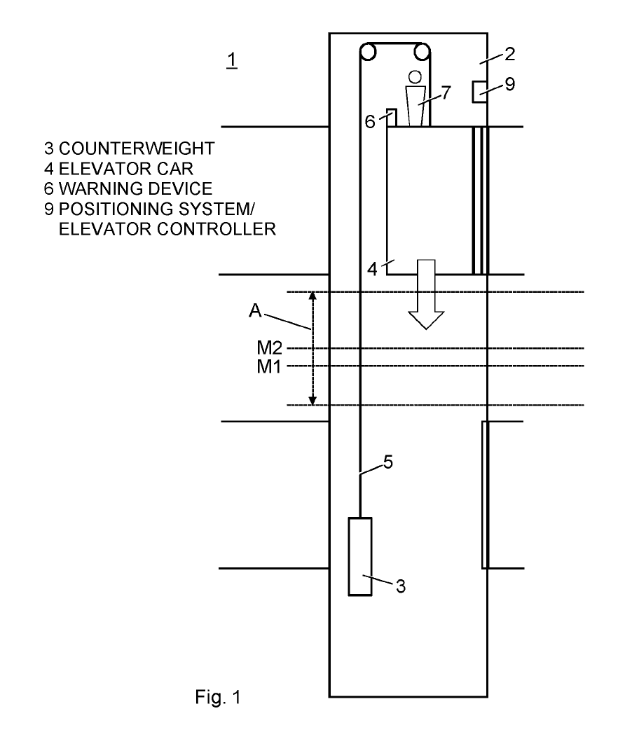

FIG. 1 shows an elevator system 1 comprising an elevator shaft 2, in which a counterweight 3 and an elevator car 4 are supported by support means 5. The elevator car 4 moves in the elevator shaft 2 in the longitudinal direction thereof and the counterweight 3 moves in the opposite direction, such that a relative movement of the counterweight 3 and the elevator car 4 towards one another or away from one another takes place.

There is an approach zone A in the elevator shaft 2. In order to ensure maximum safety, the length of the approach zone A in the longitudinal direction is advantageously greater than or equal to half the height I_{G} of the counterweight 3 plus the predetermined length I_{P} of the height 7 of a person and an optional safety clearance I_{B} of 0.5 meters, for example.

$$a = \frac{1}{2} ( {l}_{P} + {l}_{B} + {l}_{G} )$$

The height 7 of a person can be specified and prestored in accordance with the average height of a person from a country in which said elevator system is installed or is intended to be installed. The average height of a person varies from country to country and ranges between approximately just about 1.6 meters in South-East Asia and a good 1.80 meters in Northern Europe.

A center line M1 of the elevator shaft 2 in the transverse direction thereof substantially coincides with a center line M2 of the approach zone A, i.e. the two center lines M1 and M2 are orthogonal to the movement direction (the longitudinal direction) and are at the same height, which is generally half the height of the elevator shaft 2. The center line M2 of the approach zone A should for example be above the center line M1 of the elevator shaft 2 by approximately half the height 7 of a person.

The counterweight 3 and the elevator car 4 approach one another and pass one another in the approach zone A in the elevator shaft 2. In order to prevent a possible collision in which a person who e.g. has to remain on the top of the elevator car 4 during maintenance work collides with the counterweight 3, the elevator car 4 moves at a lower speed in the approach zone A. When the elevator car 4 leaves the approach zone A, the speed thereof is set back to a higher speed, namely a normal travel speed or a high maintenance speed of the elevator car 4.

The elevator system 1 also comprises a warning device 6 such as a speaker, vibration alarm or a visual means. As an additional measure, an acoustic, vibrating and/or visual alarm signal can alternatively be generated by this warning device 6 when initiating the second speed, in order to give the persons greater warning of the danger.

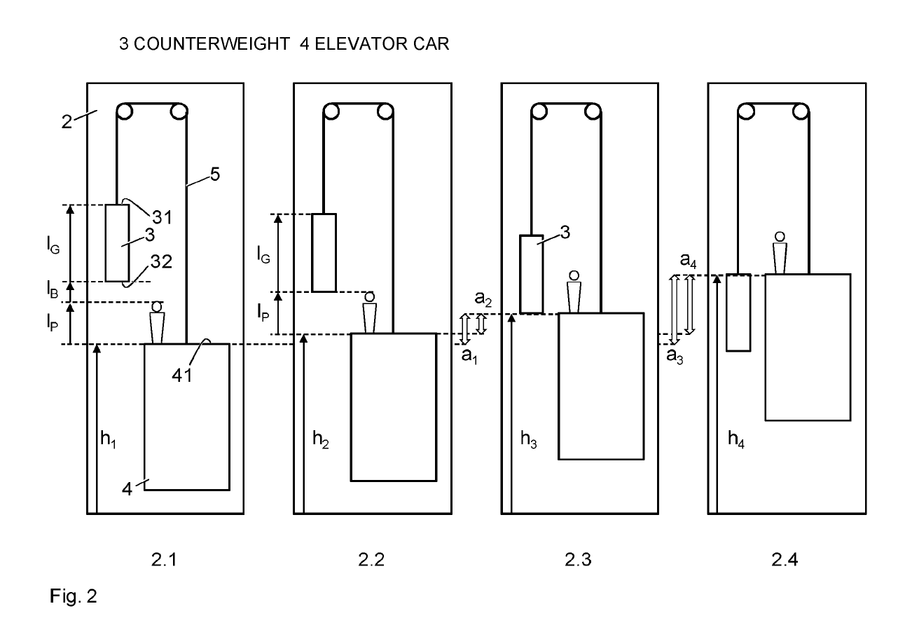

FIG. 2 shows, in four schematic views, how the length of the approach zone A is determined. The four figures, FIGS. 2.1 to 2.4, show a chronological sequence of the elevator system with the elevator car 4 moving upwards and the counterweight 3 moving downwards when viewed from left to right, or a chronological sequence with the elevator car 4 moving downwards and the counterweight 3 moving upwards when viewed from right to left.

When the elevator car is moving upwards, the elevator car 4 enters an approach zone at the point in time shown in FIGS. 2.1 and 2.2, and leaves said zone again at the point in time shown in FIGS. 2.3 and 2.4. The approach zone is considered to be reached once the vertical distance between the top 41 of the elevator car and the lower edge 32 of the counterweight have reached or come below the predetermined height I_{P} of a person plus a safety clearance I_{B}. At this moment, the top of the elevator car has reached the height h₁. The safety clearance means that a person on the top of the elevator car has enough time to move away from the edge so as not to come into contact with the counterweight.

If a safety clearance is not provided, the reaction time is accordingly reduced. In this case, the approach zone according to FIG. 2.2 is only considered to be reached when the vertical distance between the top 41 of the elevator car and the lower edge 32 of the counterweight have reached or fallen below the predetermined height I_{P} of a person. At this moment, the top of the elevator car has reached the height h₂.

The speed of the elevator system is now reduced until the elevator car is considered to have left the approach zone again. In a first variant at the point in time shown in FIG. 2.3, this is the case when the lower edge 32 of the counterweight crosses the top 41 of the elevator car. At this moment, the top of the elevator car has reached the height h₃. The risk of getting caught between the counterweight and the elevator car is significantly reduced from this point in time onwards. However, due to the counterweight moving downwards, a person on the top of the elevator car still needs to pay extra attention.

Alternatively, the elevator car is only considered to have left the approach zone at the point in time shown in FIG. 2.4 when the top 41 of the elevator car has moved above the upper edge 31 of the counterweight, which is moving downwards. At this moment, the top of the elevator car has reached the height h₄. Since the entirety of the counterweight has disappeared below the top of the elevator car, there is no longer any danger posed by the counterweight. Optionally, the elevator car is only considered to have left the approach zone when a safety clearance between the upper edge of the counterweight moving downwards and the top of the elevator car is reached. This optional variant is not shown in FIG. 2.

If the elevator car is considered to have left the approach zone, the speed of the elevator system is increased again.

The absolute length of the approach zone depends on the relevant entry height and exit height. Based on the top of the elevator car, the difference between the heights h₃ and h₂ gives the minimum vertical extent of the approach zone a₂. When the elevator car and the counterweight are moving at the same speed, the minimum vertical extent of the approach zone corresponds to half the height of a person.

$${a}_{2} = \frac{1}{2} {l}_{P}$$

If the safety clearance I_{B} is added thereto, again based on the top of the elevator car, the difference between the heights h₃ and h₁ gives the minimum vertical extent of the approach zone a₁. When the elevator car and the counterweight are moving at the same speed, in this case the extent of the approach zone corresponds to half the height of a person plus half the safety clearance.

$${a}_{1} = \frac{1}{2} ( {l}_{P} + {l}_{B} )$$

If the approach zone is also extended beyond the length of the counterweight for an additional level of safety, the vertical extension of the approach zone increases again by half the length of the counterweight. The following values therefore result for the above-described additional approach zones:

$${a}_{3} = \frac{1}{2} ( {l}_{P} + {l}_{B} + {l}_{G} )$$

$${a}_{4} = \frac{1}{2} ( {l}_{P} + {l}_{G} )$$

If the elevator car is moving from the top downwards, the limits of the approach zones are swapped, such that the speed is reduced when the upper edge of the counterweight approaches (optional safety clearance (not shown)) or moves above (FIG. 2.4) the top of the elevator car. The normal speed can be reinstated once the counterweight has moved upwards out of the range of the height of a person (FIG. 2.2), plus a potential safety clearance (FIG. 2.1).

In absolute terms, the approach zones, as described in FIG. 2, are approximately in the middle of the elevator shaft. More precisely, the approach zones can be positioned on the basis of FIG. 2.4. When the elevator car is moving upwards, the end of the approach zone is at the height h₄, at which the upper edge 31 of the counterweight and the top 41 of the elevator car align. The start of the approach zone is accordingly below this height by the vertical length a₃ or a₄. If the point in time shown in FIG. 2.3 is considered to be the exit from the approach zone, when the elevator car is moving upwards the end of the approach zone is at the height h₃, at which the lower edge 32 of the counterweight and the top 41 of the elevator car align. The start of the approach zone is accordingly below this height by the vertical length a₁ or a₂.

When the elevator car is moving downwards, the start and the end of the approach zone are accordingly swapped.

A change in the speed S is for example activated by an elevator controller 9 depending on a position of the elevator car 4 in the elevator shaft 2, the position having been determined by a positioning system 9.

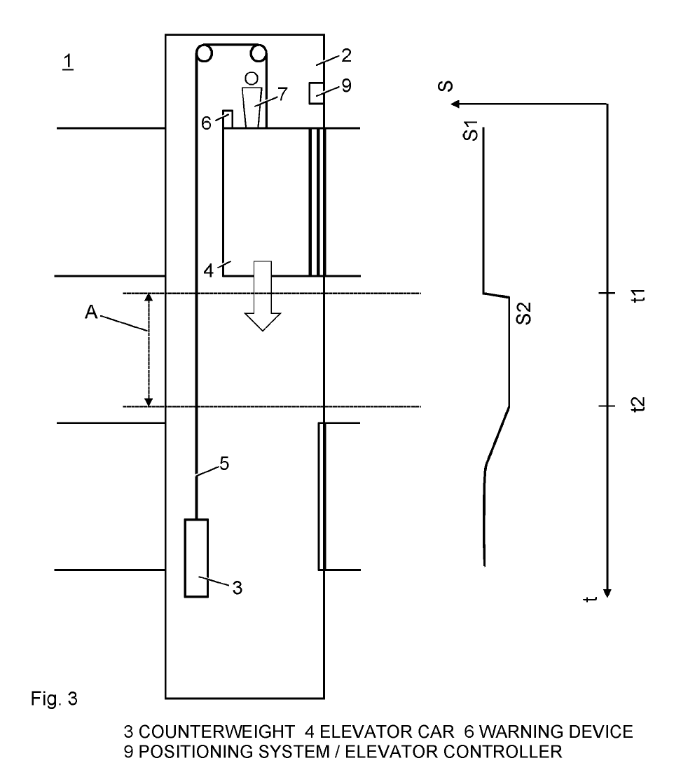

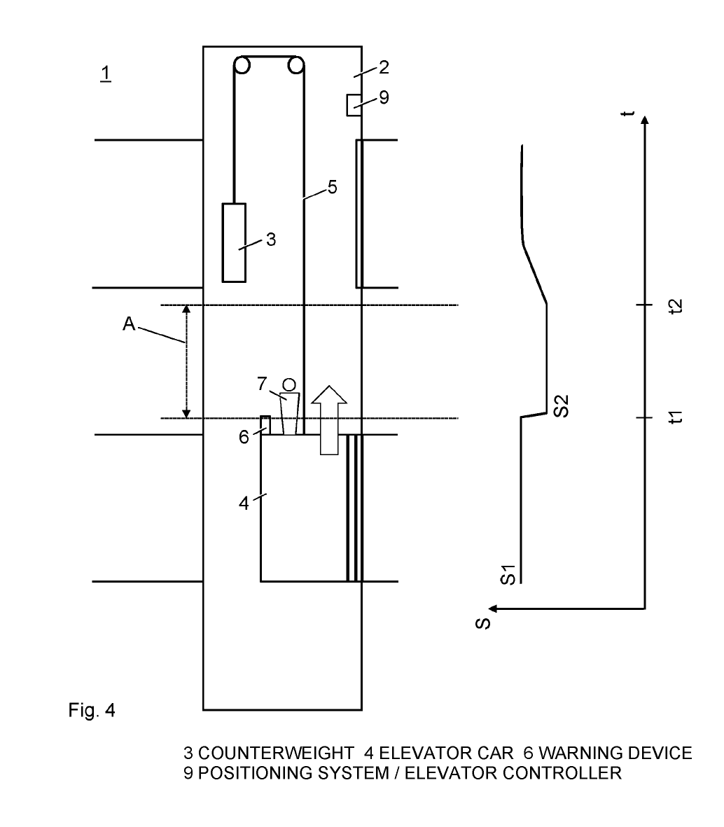

By means of a speed/time coordinate system, an operating method for an elevator system of this type is shown in FIG. 3 and FIG. 4, and said figures show how and when the travel speed S of the elevator car 4 is changed between a first speed S1 and a second speed S2. FIG. 3 shows the progression of the travel speed S of the elevator car 4 when it is moving from the top towards the bottom and counter to the rising counterweight 3. The elevator car 4 sets off at a first speed S1, e.g. the more normal operating speed or a high maintenance speed. The elevator car 4 approaches the counterweight 3. At the point in time t1, the top of the elevator car enters the approach zone by the upper edge of the counterweight crossing the edge of the top of the elevator car, or in any case crossing a notional edge below the safety clearance. At this point in time t1, the speed S1 is changed to the lower, second speed S2, e.g. a (low) maintenance speed, abruptly, i.e. with one or more perceptible, sharp changes in speed. A person on the top of the elevator car is warned of said elevator car crossing the counterweight by the abrupt deceleration or perceptible juddering from the several sharp decelerations. At the point in time t2, the top of the elevator car 4 leaves the approach zone A and the elevator car 4 moves away from the counterweight 3. Here, the speed S2 is gradually changed back to the higher speed S1 again. Optionally, the acceleration may even be initiated before leaving the approach zone. In this case, at the point in time t1 the speed curve would show a sharp, single or multiple-part reduction, followed by a gradual, continuous acceleration.

By contrast with FIG. 3, FIG. 4 shows the progression of the travel speed S of the elevator car 4 when it is moving from the bottom towards the top and counter to the counterweight 3. The elevator car 4 likewise sets off at a first speed S1. At the point in time t1, the top of the elevator car 4 first moves into the approach zone A and approaches the lower edge of the counterweight 3. The speed S1 is changed to the low speed S2. At the point in time t2, the top of the elevator car 4 moves out of the approach zone A and leaves the counterweight 3. The speed S2 is changed back to the higher speed S1 again. Again, the deceleration at the point in time t1 can take place all at once or in multiple parts, and the acceleration can take place when leaving the approach zone (t2) or at an earlier point time after t1.

It is clear from the two characteristic curves for the travel speed that the progression of the characteristic curve is steeper when the speed changes from S1 to S2 than from S2 to S1. The reason is that the second speed S2 needs to be set to be lower than the first speed S1 in order to make the change from S1 to S2 perceptible to humans. A person who is e.g. carrying out maintenance work on the top of the elevator car 4 can thus tell that the counterweight 3 will move past the elevator car 4. Because a potential risk of collision with the moving counterweight 3 is noticed in good time and the elevator car 4 and the counterweight 3 are moving slower, with decelerated acceleration (t2), the person 7 has more time to react and prevent an accident.

In FIGS. 3 and 4, it is clear from the characteristic curve that changing back from the second speed S2 to the first speed S1 is a more gradual transition than the change from S1 to S2. This means that the change in speed when changing back is slower than the change from the first speed S1 to the second speed S2. As a result, the safety of the person working on the top of the car is further improved because they can maintain their position and keep their balance better and more safely.

A warning device 6, such as a speaker, a vibration alarm or visual means, is activated when changing the speed from S1 to S2 or at the point in time t1 as an additional safety measure, and an acoustic, vibrating and/or visual alarm signal is generated in order to better protect the person on top of the car against the risk of a collision.

This operating method can be initiated and carried out for maintenance work, installation and/or a test process for an elevator system 1 either automatically by a control system of the elevator system or manually by a person who remains on the top of the car of the elevator system 1 to complete work.

In accordance with the provisions of the patent statutes, the present invention has been described in what is considered to represent its preferred embodiment. However, it should be noted that the invention can be practiced otherwise than as specifically illustrated and described without departing from its spirit or scope.

### LIST OF REFERENCE SIGNS

1 Elevator system
2 Elevator shaft
3 Counterweight
31 Upper edge of the counterweight
32 Lower edge of the counterweight
4 Elevator car
41 Top of the elevator car
5 Support means
6 Warning device
7 Height of a person
9 Positioning system/elevator controller
A Approach zone
aₙ Vertical extent of the approach zone (n={1, 2, 3, 4})
hₙ Absolute vertical height of the top of the elevator car (n={1, 2, 3, 4})
lₓ Length (X={B (safety clearance), G (counterweight), P (height of person)})
M1 Center line of the elevator shaft
M2 Center line of the approach zone
S Travel speed of the elevator car
S1 First speed
S2 Second speed
t Travel time
t1 Point in time of change from S1 to S2
t2 Point in time of change back from S2 to S1

1-14. (canceled)

15. An elevator system including an elevator shaft, an elevator car and a counterweight arranged in the elevator shaft and being connected by support means guided by at least one diverting means, such that the elevator car and the counterweight move in opposite directions, the elevator car approaching the counterweight and/or passing the counterweight in the elevator shaft in an approach zone, comprising:
an elevator controller that moves the elevator car at a first speed when the elevator car is outside of the approach zone and, when the elevator car is entering the approach zone, decelerates the elevator car to a second speed, the second speed being lower than the first speed.

16. The elevator system according to claim 15 wherein a length of the approach zone in a movement direction of the elevator car is greater than or equal to half a length of a predetermined height of a person plus an optional safety clearance.

17. The elevator system according to claim 16 wherein the height of a person is predetermined in accordance with an average height of a person from a country in which the elevator system is installed or is intended to be installed.

18. The elevator system according to claim 16 wherein the length of the approach zone in the movement direction of the elevator car corresponds to half a total of a length of the predetermined height of a person, a length of the counterweight and a length of the optional safety clearance.

19. The elevator system according to claim 15 wherein an upper boundary of the approach zone is at a height in the elevator shaft at which an upper edge of the counterweight and a top of the elevator car cross when the counterweight and the elevator car are passing.

20. The elevator system according to claim 15 wherein the elevator controller decelerates the elevator car from the first speed to the second speed sharply, or in a plurality of sharp, partial deceleration stages.

21. The elevator system according to claim 15 wherein the elevator controller accelerates the elevator car from the second speed to the first speed continuously.

22. The elevator system according to claim 15 wherein the elevator controller begins accelerating the elevator car from the second speed to the first speed after the elevator car leaves the approach zone.

23. The elevator system according to claim 15 including a warning device for generating at least one of an acoustic, a vibrating and a visual alarm signal in response to the elevator car changing from the first speed to the second speed.

24. An operating method for an elevator system that includes an elevator shaft, an elevator car and a counterweight arranged in the elevator shaft and being connected by support means guided by at least one diverting means, such that the elevator car and the counterweight move in opposite directions, the elevator car approaching the counterweight and/or passing the counterweight in the elevator shaft in an approach zone, comprising the steps of:
moving the elevator car at a first speed when the elevator car is outside of the approach zone;
when the elevator car is entering the approach zone, decelerating the elevator car to a second speed, the second speed being lower than the first speed;
setting an upper boundary of the approach zone at a height in the elevator shaft at which an upper edge of the counterweight and a top of the elevator car cross when the counterweight and the elevator car are passing one another; and
setting a length of the approach zone in a movement direction of the elevator car greater than or equal to half a length of a predetermined height of a person plus an optional safety clearance.

25. The operating method according to claim 24 including decelerating the elevator car from the first speed to the second speed sharply, or in a plurality of sharp, partial deceleration stages.

26. The operating method according to claim 24 including accelerating the elevator car from the second speed to the first speed continuously.

27. The operating method according to claim 24 including generating at least one of an acoustic, a vibrating and a visual alarm signal when the elevator car is changing from the first speed to the second speed.

28. The operating method according to claim 24 including accelerating the elevator car from the second speed to the first speed beginning after the elevator car leaves the approach zone.
